(19) United States
(12) Patent Application Publication
(10) Pub. No.: US 2018/0066096 A1
(43) Pub. Date: Mar. 8, 2018

(54) STAR COPOLYMER AND USE THEREOF AS A VISCOSITY IMPROVER

(71) Applicant: TOTAL MARKETING SERVICES, Puteaux (FR)

(72) Inventors: Raphaele IOVINE, MORNANT (FR); Gregory DESCROIX, BRINDAS (FR); Jean-Francois TASSIN, CHANGE (FR); Damien CHAVEROUX, PRIGONRIEUX (FR)

(21) Appl. No.: 15/561,532

(22) PCT Filed: Mar. 29, 2016
(86) PCT No.: PCT/EP2016/056812

§ 371 Date: Sep. 26, 2017

(30) Foreign Application Priority Data
Mar. 30, 2015 (FR) 1552660

(51) Int. Cl. C08F 257/02; C08F 210/06; C08F 210/02; C10M 169/04; C10M 143/10; C10M 143/04

(52) U.S. Cl. CPC C08F 257/02; C08F 210/06; C08F 210/02; C08F 2800/20; C10M 143/10; C10M 143/04; C10M 169/04

(57) ABSTRACT

Disclosed is a star copolymer (C) including at least 10 wt. % of units derived from styrene monomer and including arms that include a statistical copolymer (EP) including ethylene units and propylene units, and the method for preparing same. Also disclosed is the use thereof in lubricating compositions, in particular for improving the viscosity index, to the lubricating compositions thus obtained and to the uses thereof.

The present invention relates to viscosity index improvers of lubricating compositions, for motor vehicles in particular. The invention more particularly concerns a star copolymer able to be used as viscosity index improver in lubricating compositions, and the lubricating compositions thus obtained that can particularly be used for engines, gearboxes or vehicle drive axles.

Developments in engines and the performance of engine lubricating compositions are inextricably linked. The more complex the design of engines, the higher the yield and optimisation of consumption and the greater the demand placed on engine lubricating compositions for which performance must be improved.

Very high compression inside engines, higher piston temperatures in particular in the portion of the upper piston segment, and very high temperatures in the engine space all place increasing demand on lubricating compositions for modern engines.

The conditions of use of petrol engines and diesel engines include both very short trips and long travel distances.

Oil change intervals are also most variable, ranging from 5 000 km for some small diesel engines up to 100 000 km for modern commercial vehicles.

The lubricating compositions used in these vehicles must therefore have improved properties and performance levels.

The formulation of these lubricating compositions also needs to be optimised to reduce energy losses caused by friction inside the engine.

A further essential requirement for engine lubricating compositions concerns aspects related to the environment. It has effectively become essential to reduce the consumption of lubricating compositions as well as fuel consumption with the objective in particular of reducing CO₂ emissions.

The type of lubricating compositions for vehicle engines has an impact on the emissions of pollutants and on fuel consumption. Lubricating compositions for vehicle engines allowing energy savings are often called <<fuel-eco>> compositions (FE).

Since driving conditions chiefly concern an urban environment, with numerous engine stops and restarts, the <<fuel-eco>> properties of lubricants must be as good at low engine speed as well as at high engine speed.

There is therefore a constant search for a reduction in energy losses in the field of vehicle lubricants.

Regarding lubricating compositions for gearboxes or drive axles, and more generally lubricating compositions for gearing, these must meet numerous requirements related in particular to driving comfort (perfect gear change, noiselessness, problem-free operation, strong reliability), to the lifetime of the assembly (reduced wear under cold conditions, no deposits and extensive thermal stability, secure oiling at high temperatures, stable viscosity and no loss through shear, long lifetime) and to heed of environmental aspects (low fuel consumption, reduced consumption of lubricating composition, low noise, easy disposal). These are requirements imposed upon lubricating compositions for manual gearboxes and axle gears.

In the motor vehicle sector, the search for reduced CO₂ emissions necessitates the development of products allowing reduced friction in gearboxes and axle differentials. This reduction of friction in gearboxes and axle differentials must be obtained for different operating conditions. Such friction reductions must concern friction within the lubricating composition but also friction between the constituent parts of gearboxes or axle differentials, in particular metal parts.

To meet these objectives, the viscosity of lubricating compositions is of utmost importance. In particular it is necessary to provide lubricating compositions having a high viscosity index (VI) and low traction coefficient. The desired lubricating compositions must have a high viscosity index to prevent cold start energy losses due to friction, but also to maintain a sufficient lubricating film on the lubricated parts after warm-up. A high viscosity index therefore guarantees a lesser drop in viscosity when temperature increases. For this purpose, VI improvers are generally added to lubricating compositions. The aim of these viscosity improvers is to ensure selective thickening of the lubricating composition as and when temperature increases to partially offset the drop in viscosity at operating temperature. These viscosity improvers are generally polymers, particularly of poly(alkyl methacrylate) type, olefin copolymers or hydrogenated styrene/diene copolymers.

However, these polymers may have an insufficient VI, insufficient engine cleanliness performance, mechanical degradation or high costs related to the need to use high contents of these polymers. In addition, these polymer chemistries do not have any specific cold start character or properties.

It is therefore of interest to provide novel VI improvers having a high VI and improved cold start properties.

It is also of interest to provide novel VI improvers having a high VI which do not deteriorate engine cleanliness.

It is also of interest to provide novel VI improvers which promote a longer engine lifetime and hence lesser engine wear.

It is also of interest to provide novel VI improvers allowing the maintaining of lubricating composition properties including under severe conditions of use (shear, elongation, slip . . . ).

It is also of interest to provide novel VI improvers having mechanical properties which exhibit little or no degradation over time, irrespective of applied forces and the duration of such forces.

It is also of interest to provide novel VI improvers having a high VI and improved cold start properties that are sustained over time.

It is also of interest to provide novel VI improvers allowing a reduction in the coefficient of friction of lubricating oils.

It is also of interest to provide VI improvers able to be absorbed on the surfaces to be lubricated, thereby creating a favourable film thickness for protection of the surfaces to be lubricated and limiting friction.

It is also of interest to provide novel VI improvers having the above advantages and for which the formulation in a lubricating composition is easy to implement.

It is also of interest to provide lubricating compositions allowing a reduction in the fuel consumption of an engine, of a vehicle equipped with a drive axle or gearbox, or a vehicle equipped with a transmission.

It is also of interest to provide lubricating compositions having <<Fuel Eco>> properties both at low engine speed and at high engine speed.

It is also of interest to provide lubricating compositions having <<Fuel Eco>> properties that are sustained over time whilst maintaining rheological and tribological properties, and ensuring maintained engine cleanliness.

To meet these objectives, the present invention proposes a star copolymer (C) comprising at least 10% by weight of styrene monomer-derived units, and having arms comprising a statistical copolymer (EP) comprising ethylene repeat units (E) and propylene repeat units (P).

In general, a star copolymer comprises a core and arms on the periphery of the core. Preferably, the star copolymer (C) of the invention comprises at least 3 arms. Preferably, the star copolymer (C) of the invention comprises from 3 to 25 arms, preferably 3 to 20 arms, preferably 3 to 15 arms, preferably 3 to 10 arms e.g. 4, 5, 6, 7 or 8 arms.

In one particular embodiment, the invention also concerns a star copolymer (C) having arms comprising an S block and an EP block.
S is a block comprising styrene monomer-derived units,
EP is a statistical copolymer comprising ethylene repeat units (E) and propylene repeat units (P), the copolymer (C) comprising at least 10% by weight of styrene monomer-derived units.

In this particular embodiment, the arms may also comprise at least one other monomer or at least one other block between block S and block EP.

In the present invention, the arms of the star copolymer (C) preferably comprise a copolymer of general formula S-EP, where
S is a block comprising styrene monomer-derived units,
EP is a statistical copolymer comprising ethylene repeat units ( [symbol] ) and propylene repeat units (P).

A star copolymer (C) is therefore preferably defined as having arms comprising a copolymer of general formula S-EP, where:
S is a block comprising styrene monomer-derived units,
EP is a statistical copolymer comprising ethylene repeat units (E) and propylene repeat units (P), the copolymer (C) comprising at least 10% by weight of styrene monomer-derived units.

It is to be understood that the copolymer (EP) of each of the arms may be the same or different.

It is also to be understood that the copolymer S-EP of each of the arms may be the same or different.

Preferably, EP is a statistical copolymer formed of ethylene repeat units and propylene repeat units. Preferably, EP is a statistical copolymer comprising units derived from an ethylene monomer (E) and units derived from a propylene monomer (P).

Preferably, S is a block formed of styrene monomer-derived units.

Preferably, S is a block formed of styrene monomer-derived units and EP is a statistical copolymer formed of ethylene repeat units (E) and propylene repeat units (P).

Preferably, S represents a block formed of styrene monomer-derived units and EP represents a statistical copolymer comprising units derived from ethylene monomer E and units derived from propylene monomer (P).

Particularly advantageously, block S, if present, is positioned on the periphery of the core of the star copolymer (C), and the copolymer EP is positioned at the ends of the arms. In particularly advantageous manner, block S of the arms, if present, can take part in the formation of the core of the star copolymer (C) of the present invention.

In one particular embodiment of the invention, the star copolymer (C) can be defined as comprising:
a cross-linked core comprising styrene monomer-derived units; and
arms comprising a statistical copolymer (EP) comprising ethylene repeat units (E) and propylene repeat units (P);

the copolymer (C) comprising at least 10% by weight of styrene monomer-derived units.

In one particular embodiment of the invention, the star copolymer (C) can be defined as comprising:
a cross-linked core comprising styrene monomer-derived units; and
arms comprising a copolymer of general formula S-EP, where:
   S is a block comprising styrene monomer-derived units,
   EP is a statistical copolymer comprising ethylene repeat units (E) and propylene repeat units (P);

the copolymer (C) comprising at least 10% by weight of styrene monomer-derived units.

The cross-linked core can particularly be obtained by using a cross-linking agent (or coupling agent) the repeat units of which are found in the core. The cross-linking agent can particularly be selected from among polyalkenyls, i.e. compounds having two non-conjugate alkenyl groups, they may be aliphatic, aromatic or heterocyclic. Particular mention can be made of dienes e.g. divinylbenzene, norboradiene . . .

In one embodiment of the invention, the arms comprising a statistical copolymer (EP) having ethylene repeat units and propylene repeat units are linked to the cross-linked core comprising styrene monomer-derived units by a bond L.

In one preferred embodiment of the invention, the bond L is selected from among carbon groups comprising at least one halogen function or one oxygenated function e.g. an ester function, alcohol function, acid function, ether function, epoxide function, acid anhydride function and derivatives thereof; carbon groups comprising at least one nitrogen-containing function e.g. amine function, amide function, imide function; carbon groups comprising at least one phosphorus-containing function e.g. phosphonic acid function, phosphoric acid; carbon groups comprising at least one sulfur-containing function e.g. sulphonyl, e.g. the groups alkylene glycol, polyethylene glycol, poly(ethylene-propylene) glycol, poly(ethylene-butylene)glycol.

In one more preferred embodiment of the invention, the bond L is selected from among carbon groups comprising at least one halogen function or epoxide function or acid anhydride function, advantageously a maleic anhydride function.

In particularly preferred manner, the star copolymer (C) of the invention comprises from 10 to 60% by weight of styrene monomer-derived units relative to the total weight of the copolymer (C), preferably 10 to 50%, preferably 10 to 40%, preferably 10 to 30%, preferably 20 to 60%, preferably 20 to 50%, preferably 20 to 40%, preferably 20 to 30%, preferably 15 to 60%, preferably 15 to 50%, preferably 15 to 40%, preferably 15 to 35%, preferably 15 to 30%, preferably 25 to 60%, preferably 25 to 50%, preferably 25 to 4%, preferably 25 to 35%, preferably 25 to 30%, preferably 30 to 60%, preferably 30 to 50%, preferably 30 to 40%, preferably 30 to 35%.

In particularly preferred manner, the star copolymer (C) of the invention comprises from 15 to 50% by weight, preferably 20 to 40%, preferably 20 to 30% by weight of styrene monomer-derived units relative to the total weight of the copolymer (C).

In the present invention, the expressions <<from x to y>> and <<between x and y>> are to be construed as including the limits x and y.

The star copolymer (C) of the present invention can be characterized by a weight-average molecular weight (Mw) of between 90 000 and 15 000 000 g/mol, preferably between 90 000 and 1 000 000 g/mol, e.g. between 90 000 and 800 000 or between 90 000 and 500 000 or between 90 000 and 300 000 or between 90 000 and 20 000 g/mol.

In the star copolymer (C) of the present invention each of the arms, the same or different, has a weight-average molecular weight (Mw) of between 25 000 and 300 000 g/mol, preferably between 25 000 and 200 000 g/mol, more preferably between 25 000 and 100 000 g/mol.

In the star copolymer (C) of the present invention, the arms are all the same or different and the molecular weight average (Mw) of the arms is preferably between 25 000 and 300 000 g/mol, preferably between 25 000 and 200 000 g/mol, more preferably between 25 000 and 100 000 g/mol.

In the present invention, the weight-average molecular weights (Mw) are obtained by Gel Permeation Chromatography (GPC).

The star copolymer (C) of the present invention is defined as having arms comprising a statistical ethylene-propylene copolymer (EP copolymer).

It is to be understood that the EP copolymer of each of the arms may be the same or different and preferably comprises from 14 to 90% by weight of ethylene repeat units relative to the total weight of the EP copolymer, preferably from 30 to 90%, preferably 40 to 90%, preferably 50 to 90%, preferably 60 to 90%, preferably 70 to 90%, preferably 80 to 90%, preferably 30 to 80%, preferably 40 to 80%, preferably 50 to 80%, preferably 60 to 80%, preferably 70 to 80%.

Preferably the EP copolymer of each of the arms may be the same or different and comprises from 50 to 80%, preferably from 60 to 80% by weight of ethylene repeat units relative to the total weight of the EP copolymer.

Preferably, the EP copolymers of each of the arms are the same or different and on average comprise from 14 to 90% by weight of ethylene repeat units relative to the total weight of the EP copolymer, preferably from 30 to 90%, preferably 40 to 90%, preferably 50 to 90%, preferably 60 to 90%, preferably 70 to 90%, preferably 80 to 90%, preferably 30 to 80%, preferably 40 to 80%, preferably 50 to 80%, preferably 60 to 80%, preferably 70 to 80%.

Preferably, the EP copolymers of each of the arms are the same or different and on average comprise from 50 to 80%, preferably from 60 to 80% by weight of ethylene repeat units relative to the total weight of the EP copolymer.

In particularly preferred manner, the star copolymer (C) of the invention:
has a weight-average molecular weight (Mw) of between 90 000 and 1 000 000 g/mol, e.g. between 90 000 and 800 000 g/mol;
comprises from 15 to 50%, preferably from 20 to 40%, preferably from 20 to 30 by weight of styrene monomer-derived units relative to the total weight of the copolymer (C); and
the EP copolymers of each of the arms are the same or different and on average comprise from 50 to 80%, preferably from 60 to 80% by weight of ethylene repeat units relative to the total weight of the EP copolymer; or the EP copolymer of the each of the arms may be the same or different and comprises from 50 to 80%, preferably from 60 to 80% by weight of ethylene repeat units relative to the total weight of the EP copolymer.

Particularly preferably, the star copolymer (C) of the invention:
has a weight-average molecular weight (Mw) of between 90 000 and 1 000 000 g/mol, e.g. between 90 000 and 800 000 g/mol;
comprises from 15 to 50%, preferably from 20 to 40%, preferably from 20 to 30 by weight of styrene monomer-derived units relative to the total weight of the copolymer (C);
the EP copolymers of each of the arms are the same or different and on average comprise from 50 to 80%, preferably from 60 to 80% by weight of ethylene repeat units relative to the total weight of the EP copolymer; or the EP copolymer of each of the arms may be the same or different and comprises from 50 to 80%, preferably from 60 to 80% by weight of ethylene repeat units relative to the total weight of the EP copolymer; and
each of the arms, the same or different, has a weight-average molecular weight (Mw) of between 25 000 and 200 000 g/mol, preferably between 25 000 and 100 000 g/mol; or the arms are all the same or different and the molecular weight average (Mw) of the arms is between 25 000 and 150 000 g/mol, preferably between 25 000 and 100 000 g/mol.

Particularly advantageously, the inventors have additionally found that the star copolymer C of the present invention may also comprise at least one polar group positioned on at least one of the arms, preferably on the EP portion of the arms and preferably at the end of the EP chain. Without wishing to be bound by any theory, the polar groups interact with the surfaces to be lubricated thereby allowing an improvement in the adhesion of the copolymer (C) of the invention, the ensured presence of a sufficient film for lubrication and hence an improvement in lubricating performance. The polar group may be selected in particular from among carbon groups comprising at least one oxygenated function e.g. an ester function, alcohol function, acid function, ether function, epoxide function, acid anhydride function and derivatives thereof; carbon groups comprising at least one nitrogen-containing function e.g. an amine function, amide function, imide function; carbon groups comprising at least one phosphorus-containing function e.g. phosphonic acid function, phosphoric acid function; carbon groups comprising at least one sulfur-containing function e.g. sulphonyl, for example the groups alkylene glycol, polyethylene glycol, poly(ethylene-propylene) glycol, poly(ethylene-butylene) glycol. Preferably the polar group is the group

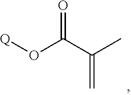

Q representing the link of the polar group to the arm of the star copolymer.

The copolymer (C) of the invention may be in pure form or in the form of a dispersion in an anhydrous medium. The anhydrous medium may notably be an oil, preferably a base oil. The dispersion obtained can be added to a base oil to form a lubricating composition, in particular such as described below.

The present invention also concerns a method for preparing a copolymer (C) such as described above.

In a first embodiment, the copolymer (C) of the present invention can be obtained with a method (P1) comprising the steps of:
a) polymerizing styrene monomers in the presence of a cross-linking agent via anionic polymerization;
b) oligomerizing a short butadiene block;
c) polymerizing ethylene and propylene monomers onto the copolymer obtained at step b) via Ziegler-Natta polymerization, for example in the presence of TiCl₄;
d) optionally hydrogenating the polymer obtained at step c);
e) recovering a star copolymer (C) of the invention.

In a second embodiment, the copolymer (C) of the invention can be obtained with a method (P2) comprising the steps of:
a) preparing ethylene and propylene monomers via Ziegler-Natta polymerization;
b) deactivating the polymer obtained at step a) with an inhibitor, preferably carrying a reactive functionalisation, in particular of alcohol type;
c) esterifying the polymer obtained at b);
d) controlled radical polymerizing of the polymer obtained at step c) with styrene monomers and a cross-linking agent;
e) optionally hydrogenating the polymer obtained at step d);
f) recovering a star copolymer C of the invention.

In a third embodiment, the copolymer C of the invention can be obtained with a method (P3) comprising the steps of:
a) preparing a core by controlled radical copolymerisation of styrene monomers in the presence of a cross-linking agent;
b) functionalising the core obtained at step a) via controlled radical polymerization by adding ethylene and propylene monomers;
c) optionally adding a polymerizable polar function to the reaction medium obtained at step b);
d) optionally hydrogenating the polymer obtained at step b) or c) as applicable;
e) recovering a star copolymer (C) of the invention.

In this particular embodiment, step c) allows the grafting of at least one group comprising at least one polar function onto the copolymer (C), preferably at the end of the chain of the EP copolymer such as defined above.

In a fourth embodiment, the copolymer (C) of the invention can be obtained with a method (P4) comprising the steps of:
a) synthesizing a core via metallocene polymerization of styrene monomers in the presence of a cross-linking agent;
b) synthesizing ethylene-propylene copolymers via metallocene polymerization of ethylene and propylene monomers;
c) recovering a star copolymer (C) of the invention.

In the above-described methods, persons skilled in the art, on the basis of their general knowledge, are able to determine the quantities of monomers to be used and the specific reaction conditions allowing the star copolymers (C) of the invention to be obtained.

In a fifth embodiment, the copolymer (C) of the invention can be obtained with a method (P5) comprising the steps of:
a) synthesizing an ethylene-propylene copolymer EP;
b) synthesizing a compound able to generate radicals comprising a group comprising at least one polar function and comprising a counter-radical (e.g. selected from among nitroxide and xanthate);
c) reacting the ethylene-propylene copolymer EP obtained at step a) with the compound able to generate radicals obtained at step b);
d) copolymerizing the copolymer obtained at step c) with styrene monomers and a cross-linking agent;
e) optionally: hydrogenation of the polymer obtained at step d);
f) recovering a star copolymer (C) of the invention preferably comprising, at the end of the chain of the EP copolymer defined above, at least one group comprising at least one polar function.

In a sixth embodiment, the copolymer (C) of the invention can be obtained with a method (P6) comprising:
a) a synthesis step of a statistical copolymer EP comprising ethylene repeat units, propylene repeat units and residual double bonds;
b) a functionalisation step of the EP copolymer derived from step a), with a nucleophilic addition reactive function;
c) a polymerization step of styrene monomers in the presence of a cross-linking agent;
d) a step to add the polymer derived from step c) to the copolymer EP derived from step b);
e) a step to recover the star copolymer (C) obtained at step d).

In one preferred embodiment of the invention, the copolymer (C) is obtained with method (P6) such as defined above.

In one more preferred embodiment of the invention, the nucleophilic addition reactive function of step b) is selected from among carbon groups comprising at least one oxygenated function e.g. an ester function, alcohol function, acid function, ether function, epoxide function, acid anhydride function, halogen function and derivatives thereof; carbon groups comprising at least one nitrogen-containing function e.g. amine function, amide function, imide function; carbon groups comprising at least one phosphorus-containing function e.g. phosphonic acid function, phosphoric acid function; carbon groups comprising at least one sulfur-containing function e.g. sulphonyl, for example the groups alkylene glycol, polyethylene glycol, poly(ethylene-propylene) glycol, poly(ethylene-butylene)glycol. Preferably, the reactive function is selected from among carbon groups comprising an epoxide function, acid anhydride function, halogen function, advantageously an epoxide function or maleic anhydride function.

In another preferred embodiment of the invention, the method (P6) comprises a step b-1) after step b) and before step c), said step b-1) comprising a step to purify the EP copolymer derived from step b).

Advantageously, step b-1) is performed by washing the EP copolymer with methanol followed by solubilisation in toluene and evaporation.

This step particularly allows that the (EP) copolymer is anhydrous and free of traces of acidity, in particular when the nucleophilic addition reactive function is selected from among carbon groups comprising at least one acid anhydride function.

In another preferred embodiment of the invention, the polymerization at step c) is anionic polymerization.

In a more preferred embodiment of the invention, the polymerization at step c) is anionic polymerization in the presence of a cross-linking agent.

The cross-linking agent can be selected from among all compounds known as cross-linking agents able to be used for anionic polymerization.

Advantageously, the cross-linking agent is divinylbenzene.

In another preferred embodiment of the invention, method (P6) comprises a step d-1) between step d) and step e), said step d-1) comprising a precipitation step of the copolymer obtained after step d), in a polar solvent.

Advantageously, the polar solvent is methanol.

The present invention also concerns a lubricating composition comprising at least one base oil and at least one star copolymer (C) of the invention.

In general, the lubricating composition of the invention may comprise any type of animal or vegetable, mineral, synthetic or natural lubricating base oil known to persons skilled in the art.

The base oils used in the lubricating compositions of the invention may be mineral or synthetic oils belonging to Groups I to V of the classes defined in the API classification (or equivalents thereof in the ATIEL classification) (Table A) or mixtures thereof.

TABLE A

| | Saturates | Sulfur | Viscosity Index |
|---|---|---|---|
| | content | content | (VI) |
| Group I | <90% | >0.03% | 80 ≤ VI < 120 |
| Mineral oils | | | |
| Group II | | | |
| Hydrocracked oils | ≥90% | ≤0.03% | 80 ≤ VI < 120 |
| Group III | | | |
| Hydrocracked or | ≥90% | ≤0.03% | ≥120 |
| hydro-isomerized oils | | | |

| | |
|---|---|
| Group IV | Polyalphaolefins (PAOs) |
| Group V | Esters and other bases non-included |
| | in Groups I to IV |

The mineral base oils of the invention include all types of base oils obtained by atmospheric and vacuum distillation of crude oil, followed by refining operations such as solvent extraction, deasphalting, solvent dewaxing, hydrotreatment, hydrocracking, hydroisomerization et hydrofinishing.

Mixtures of synthetic and mineral oils can also be used.

In general, there is not limit as to the use of different lubricating bases to produce the lubricating compositions of the invention, other than that they must have properties of viscosity, viscosity index, sulfur content and oxidation resistance in particular that are adapted for use in engines or for vehicle transmission parts.

The base oils of the lubricating compositions of the invention may also be selected from among synthetic oils such as some esters of carboxylic acids and alcohols, and from among polyalphaolefins. The polyalphaolefins used as base oils are obtained for example from monomers having 4 to 32 carbon atoms, e.g. from octene or decene and having a viscosity at 100° C. of between 1.5 and 15 mm²·s⁻¹ as per the ASTM D445 standard. Their molecular weight average is generally between 250 and 3 000 as per the ASTM D5296 standard.

Preferably, the base oils of the present invention are selected from among the above base oils having an aromatic content of between 0 and 45%, preferably between 0 and 30%. The aromatic content of the oils is measured according to the UV Burdett method. Without wishing to be bound by any theory, the aromaticity of the base oil is a characteristic allowing optimised behaviour of the polymer as a function of temperature. The choice of a low-aromatic oil gives an optimum at highest temperatures.

Advantageously, the lubricating composition of the invention comprises at least 50% by weight of base oils relative to the total weight of the composition.

More advantageously, the lubricating composition of the invention comprises at least 60 by weight, even at least 70% by weight of base oils relative to the total weight of the composition.

In particularly further advantageous manner, the lubricating composition of the invention comprises 60 to 99.5% by weight of base oils, preferably 70 to 99.5% by weight of base oils relative to the total weight of the composition.

Numerous additives can be used for this lubricating composition of the invention.

The preferred additives for the lubricating composition of the invention are selected from among detergent additives, anti-wear additives, friction modifying additives, extreme-pressure additives, dispersants, pour point improvers, defoaming additives, thickeners and mixtures thereof.

Preferably, the lubricating composition of the invention comprises at least one anti-wear additive, at least one extreme-pressure additive or mixtures thereof.

Anti-wear additives and extreme-pressure additives protect friction surfaces through the formation of a protective film adsorbed on these surfaces.

There exists a wide variety of anti-wear additives. Preferably, for the lubricating composition of the invention, the anti-wear additives are selected from among phospho-sulfurized additives such as metal alkylthiophosphates, in particular zinc alkylthiophosphates, and more specifically zinc dialkyldithiophosphates or ZnDTPs. The preferred compounds have the formula Zn((SP(S)(OR¹)(OR²))₂, where R¹ and R², the same or different, are each independently an alkyl group, preferably an alkyl group having 1 to 18 carbon atoms.

Amine phosphates are also anti-wear additives that can be used in the lubricating composition of the invention. However, the phosphorus contributed by these additives may act as poison for catalytic systems of motor vehicles since these additives generate ash. These effects can be minimised by partly substituting amine phosphates by additives that do not contain phosphorus such as polysulfides for example, in particular sulfurized olefins.

Advantageously the lubricating composition of the invention may comprise from 0.01 to 6% by weight, preferably 0.05 to 4% by weight, more preferably 0.1 to 2% by weight of anti-wear additives and extreme-pressure additives relative to the total weight of the lubricating composition.

Advantageously, the lubricating composition of the invention may comprise at least one friction modifying additive. The friction modifying additive can be selected from among a compound providing metal elements and an ash-free compound. Among the compounds providing metal elements, mention can be made of transition metal complexes such as Mo, Sb, Sn, Fe, Cu, Zn, the ligands of which may be hydrocarbon compounds comprising atoms of oxygen, nitrogen, sulfur or phosphorus. The ash-free friction modifying additives are generally of organic origin and can be selected from among the monoesters of fatty acids and polyols, alkoxylated amines, alkoxylated fatty amines, fatty epoxides, borate fatty epoxides; fatty amines or fatty acid glycerol esters. According to the invention, the fatty compounds comprise at least one hydrocarbon group having 10 to 24 carbon atoms. Advantageously, the lubricating composition of the invention may comprise from 0.01 to 2% by weight, or 0.01 to 5% by weight, preferably from 0.1 to 1.5% by weight or 0.1 to 2% by weight of friction modifying additive relative to the total weight of the lubricating composition.

Advantageously, the lubricating composition of the invention may comprise at least one antioxidant additive.

An antioxidant additive generally allows delayed degradation of the lubricating composition in use. This degradation may notably translate as the formation of deposits, as the presence of sludge or as an increase in viscosity of the lubricating composition.

Antioxidant additives particularly act as radical inhibitors or hydroperoxide decomposers. Among the antioxidant additives frequently employed, mention can be made of antioxidant additives of phenolic type, antioxidant additives of amino type, phosphor-sulfurized antioxidant additives. Some of these antioxidant additives e.g. phospho-sulfurized antioxidant additives may generate ash. Phenolic antioxidant additives may be ash-free or may be in the form of neutral or basic metal salts. Antioxidant additives can be selected in particular from among sterically hindered phenols, sterically hindered phenol esters and sterically hindered phenols comprising a thioether bridge, diphenylamines, diphenylamines substituted by at least one C₁-C₁₂ alkyl group N,N′-dialkyl-aryl-diamines, and mixtures thereof.

Preferably, according to the invention, the sterically hindered phenols are selected from among compounds comprising a phenol group wherein at least one vicinal carbon of the carbon carrying the alcohol function is substituted by at least one C₁- C₁₀ alkyl group, preferably a C₁-C₆ alkyl group, preferably a C₄ alkyl group, preferably by the tert-butyl group.

Amino compounds are another class of antioxidant additives that can be used, optionally in combination with phenolic antioxidant additives. Examples of amino compounds are the aromatic amines e.g. the aromatic amines of formula NR³R⁴R⁵ where R³ is an aliphatic group or aromatic group, optionally substituted, R⁴ is an aromatic group, optionally substituted, R⁵ is a hydrogen atom, an alkyl group, an aryl group or a group of formula R⁶S(O)_{Z}R⁷ where R⁶ is an alkylene group or alkenylene group, R⁷ is an alkyl group, an alkenyl group or aryl group and z is 0, 1 or 2.

Sulfurized alkyl phenols or the alkaline or alkaline-earth metal salts thereof can also be used as antioxidant additives.

Another class of antioxidant additives is that of copper compounds e.g. copper thio- or dithio-phosphates, copper and carboxylic acid salts, copper dithiocarbamates, sulfonates, phenates and acetylacetonates. Copper I and II salts, the salts of succinic acid or anhydride can also be used.

The lubricating composition of the invention may contain any type of antioxidant additives known to persons skilled in the art.

Advantageously, the lubricating composition comprises at least one ash-free antioxidant additive.

Also advantageously, the lubricating composition of the invention comprises from 0.5 to 2% by weight of at least one antioxidant additive relative to the total weight of the composition.

The lubricating composition of the invention may also comprise at least one detergent additive.

Detergent additives generally allow a reduction in the formation of deposits on the surface of metal parts by dissolving secondary oxidation and combustion products.

The detergent additives that can be used in the lubricating composition of the invention are generally known to persons skilled in the art. The detergent additives may be anionic compounds comprising a long lipophilic hydrocarbon chain and hydrophilic head. The associated cation may be a metal cation of an alkaline or alkaline-earth metal.

The detergent additives are preferably selected from among the salts of alkaline metals or alkaline-earth metals of carboxylic acids, sulfonates, salicylates, naphthenates, and phenate salts. The alkaline or alkaline-earth metals are preferably calcium, magnesium, sodium or barium.

These metal salts generally comprise the metal in stoichiometric amount or in excess i.e. an amount greater than the stoichiometric amount. They are then overbased detergent additives; the excess metal imparting the overbased nature to the detergent additive is then generally in the form of an oil-insoluble metal salt e.g. a carbonate, hydroxide, an oxalate, acetate, glutamate, preferably a carbonate.

Advantageously, the lubricating composition of the invention may comprise from 2 to 4 by weight of detergent additive relative to the total weight of the lubricating composition.

Also advantageously, the lubricating composition of the invention may additionally comprise at least one pour point depressant additive.

By slowing the formation of paraffin crystals, pour point depressants generally improve the behaviour of the lubricating composition of the invention under cold temperatures.

As examples of pour point depressant additives, mention can be made of alkyl polymethacrylates, polyacrylates, polyarylamides, polyalkylphenols, polyalkylnaphthalenes, alkylated polystyrenes.

Advantageously the lubricating composition of the invention may also comprise at least one dispersant.

The dispersant can be selected from among Mannich bases, succinimides and derivatives thereof.

Also advantageously, the lubricating composition of the invention may comprise from 0.2% to 10% by weight of dispersant relative to the total weight of the lubricating composition.

The lubricating composition may also comprise at least one additional polymer to improve the viscosity index. As examples of additional polymer to improve the viscosity index, mention can be made of polymer esters, homopolymers or copolymers, hydrogenated or non-hydrogenated, styrene, butadiene and isoprene, polymethacrylates (PMAs).

The lubricating composition of the invention may be in different forms. In particular, the lubricating composition of the invention may be an anhydrous composition. Preferably, this lubricating composition is not an emulsion.

The lubricating composition of the present invention preferably comprises from 0.1 to 50% by weight of star copolymer (C) such as defined above, relative to the total weight of the lubricating composition, preferably 0.5 to 30 weight %.

Preferably, for use in engines, the lubricating composition of the present invention comprises from 0.1 to 10% by weight of star copolymer C such as defined above, relative to the total weight of the lubricating composition, preferably 0.5 to 5 weight %.

Preferably, for use in transmission parts, the lubricating composition of the present invention comprises 5 to 50% by weight of star copolymer (C) such as defined above, relative to the total weight of the lubricating composition, preferably 10 to 30 weight %.

The present invention also concerns the use of a copolymer (C) of the invention as viscosity index improver of a lubricating composition. Preferably, the use of a copolymer (C) of the invention allows viscosity indexes of at least 200 to be reached. The viscosity index is measured as per the ASTM D2270 or ISO standard.

Preferably, the copolymer (C) is used in a proportion of 0.1 to 50% by weight, relative to the total weight of the lubricating composition, preferably 0.5 to 30 weight %.

Preferably, for use in engines, the copolymer C is used in a proportion of 0.1 to 10% by weight relative to the total weight of the composition, preferably 0.5 to 5 weight %.

Preferably, for use in transmission parts, the copolymer C is used in a proportion of 0.1 to 50% by weight relative to the total weight of the composition, preferably 0.5 to 30 weight %.

The above-indicated ranges apply to the pure copolymer or to the dispersion of the copolymer in an anhydrous medium such as defined above.

The present invention also concerns the use of a copolymer C such as defined above:
to reduce the coefficient of friction of a lubricating composition; or
in a lubricating composition, to reduce engine fuel consumption, in particular a motor vehicle engine; or
in a lubricating composition, to reduce the fuel consumption of a vehicle equipped with a drive axle or gearbox; or
in a lubricating composition, to reduce the fuel consumption of a vehicle equipped with a transmission; or
to reduce the traction coefficient of lubricating compositions, in particular for transmissions or gearboxes; or
to improve the Fuel Eco (FE) of a lubricating composition.

Preferably, the copolymer (C) is used in a proportion of 0.1 to 50% by weight relative to the total weight of the lubricating composition, preferably 0.5 to 30 weight %.

Preferably, for use in engines, the copolymer (C) is used in a proportion of 0.1 to 10% by weight relative to the total weight of the composition, preferably 0.5 to 5 weight %.

Preferably, for use in transmissions, the copolymer (C) is used in a proportion of 0.1 to 50% by weight relative to the total weight of the composition, preferably 0.5 to 30 weight %.

The above-indicated ranges apply to the pure copolymer or to the dispersion of the copolymer in an anhydrous medium such as defined above.

The invention also concerns the use of a lubricating composition such as defined above:
to reduce engine fuel consumption, in particular a motor vehicle engine; or
to reduce the fuel consumption of a vehicle equipped with a drive axle or gearbox; or
to reduce the fuel consumption of a vehicle equipped with a transmission.

The invention also concerns a method to modify the viscosity index of a lubricating composition, comprising the addition to said lubricating composition of a star copolymer (C) according to the invention.

In this method, the copolymer (C) is used in a proportion of 0.1 to 50% by weight relative to the total weight of the lubricating composition, preferably 0.5 to 30 weight %.

Preferably, for use in engines, the copolymer (C) is used in a proportion of 0.1 to 10% by weight relative to the total weight of the composition, preferably 0.5 to 5 weight %.

Preferably, for use in transmissions, the copolymer C is used in a proportion of 0.1 to 50 by weight relative to the total weight of the composition, preferably 0.5 to 30 weight %.

The above-indicated ranges apply to the pure copolymer or to the dispersion of the copolymer in an anhydrous medium such as defined above.

The invention also concerns a method:
to reduce the coefficient of friction of a lubricating composition; or
to reduce fuel consumption of an engine, a motor vehicle engine in particular; or
to reduce the fuel consumption of a vehicle equipped with a drive axle or gearbox; or
to reduce the fuel consumption of a vehicle equipped with a transmission; or
to reduce the traction coefficient of lubricating compositions in particular for transmissions or gearboxes; or
to improve the Fuel Eco (FE) of a lubricating composition;

comprising the addition of a star copolymer C of the invention to said lubricating composition, or to the lubricating composition used in said engine or in said vehicles.

In this method, the copolymer C is used in a proportion of 0.1 to 50% by weight relative to the total weight of the lubricating composition, preferably 0.5 to 30 weight %.

Preferably, for use in engines the copolymer C is used in a proportion of 0.1 to 10% by weight relative to the total weight of the composition, preferably 0.5 to 5 weight %.

Preferably, for use in transmissions the copolymer C is used in a proportion of 0.1 to 50% by weight relative to the total weight of the composition preferably 0.5 to 30 weight %.

The ranges indicated above apply to the pure copolymer or to the dispersion of the copolymer in an anhydrous medium such as defined above.

The invention also concerns a method:
to reduce engine fuel consumption, in particular a motor vehicle engine; or
to reduce the fuel consumption of a vehicle equipped with a drive axle or gearbox; or
to reduce the fuel consumption of a vehicle equipped with a transmission;

comprising the use of a lubricating composition of the invention.

By analogy, the particular, advantageous or preferred characteristics of the star copolymer (C) of the invention or of the lubricating composition of the invention define particular, advantageous or preferred uses of the invention.

The invention will now be described using nonlimiting examples.

### EXAMPLE 1

### Preparation of a Star Copolymer (C) of the Invention

The entire preparation method is conducted in a controlled nitrogen atmosphere. Also, all the monomers are purified on a neutral, activated aluminium oxide column and stored on a 4A molecular sieve in an inert atmosphere. The solution of sec-BuLi used is 1.4 M in hexane.

A 2L reactor equipped with mechanical agitator (anchor type) and counter blade is charged with 500 mL anhydrous toluene (purification via azeotropic entrainment), 1.0 mL of Styrene (8.7 mmol) and 1.20 mL of N,N,N′,N′-tetramethylethylenediamine (4.0 mmol). The solution obtained is degassed with three vacuum/nitrogen cycles and cooled to −20° C. under agitation (200 rpm). The proton impurities are neutralized with the dropwise addition of sec-Butyllithium until a persistent orange/yellow colouring is obtained (amount of sec-BuLi varying between 0.2 and 0.6 mL). The sec-BuLi charge is then rapidly added (2.85 mL, 4 mmol) under 350 rpm agitation, followed by the addition of 1, 12 mL divinylbenzene (8 mmol). The medium quickly takes on a dark red colouring. The medium is left under agitation 30 min at −20 ° C. (200 rpm). The styrene (15 mL, 130 mmol) is then quickly added at −20 ° C. The medium is heated to 50 ° C. for 2h, then lowered to ambient temperature (the medium is of bright orange colour). A solution of statistical ethylene/propylene copolymer comprising maleic anhydride functions (V4021 distributed by FUNCTIONAL PRODUCTS INC and later called OCP/MAH) is added to the medium using a cannula in an inert atmosphere.

Before addition, the OCP/MAH is purified with the following method: in a round bottom flask equipped with mechanical agitation, 30 g of OCP/MAH are solubilised in 500 mL toluene. The copolymer dissolves in 16h under vigorous agitation at 35° C. The copolymer is then precipitated in 1.5 L of MeOH under vigorous agitation. The solid is washed with 500 mL additional methanol by trituration. The solid is then dried under reduced pressure at 40° C. for 4h.

The OCP/MAH obtained (28.5 g) is dissolved in 700 mL toluene. The solution obtained is placed under nitrogen reflux in an assembly of Dean-Stark type for 24h with regular draining of the toluene/water binary in the Dean-Stark apparatus. The solution is then cooled to ambient temperature for IR analysis.

The addition is halted as soon as the orange colour has fully disappeared (pale yellow medium) (75% by volume of solution i.e. 21 g of OCP). 20 mL of methanol are added to quench the reaction. The copolymer obtained is purified by precipitation and washed by trituration in 2L of methanol. The copolymer is vacuum dried overnight at ambient temperature.

The copolymer (C) obtained is a star copolymer comprising 34% by weight of styrene repeat units (measured by NMR spectroscopy) and arms comprising a statistical ethylene/propylene copolymer.

### EXAMPLE 2

### Evaluation of the Viscosity Index Improving Properties of a Star Copolymer (C) of the Invention

The star copolymer of Example 1 was solubilised in the following base oils:
base oil 1: Group I base oil (kinematic viscosity measured at 100° C. as per ISO standard: 3104=5.19 mm²/s)
base oil 2: Group V base oil of alkylnaphthalene type (Synesstic 5 marketed by Exxonmobil)

For solubilisation, 1 g of star copolymer of Example 1 was solubilised in 100 g of base oil and subjected to agitation on a magnetic hot plate at 150° C. for 96 h.

Each mixture was then filtered and centrifuged.

Mixtures 1 and 2 thus prepared are described in Table I (the values given correspond to weight percentages).

TABLE I

| | Mixture 1 | Mixture 2 |
|---|---|---|
| Star copolymer of Example | 0.9 | 0.9 |
| 1 | | |
| Base oil 1 | 99.1 | |
| Base oil 2 | | 99.1 |

The viscosity index of mixtures 1 and 2, and of the base oils 1 and 2 were measured in accordance with standard ISO 2909; the results are given in Table II.

TABLE II

| | Base oil 1 | Mixture 1 | Base oil 2 | Mixture 2 |
|---|---|---|---|---|
| Viscosity Index | 104 | 118 | 79 | 145 |
| (VI) | | | | |

These results show that the star copolymer (C) of the invention allows the viscosity index of a base oil to be improved, irrespective of the type of base oil.

These results therefore demonstrate that the star copolymer of the invention can be used in a lubricating composition as VI improver.

1-20. (canceled)

21. Star copolymer (C) comprising at least 10% by weight of styrene monomer-derived units and having arms comprising a statistical copolymer (EP) comprising ethylene repeat units and propylene repeat units.

22. The copolymer (C) according to claim 21, having arms comprising a copolymer of general formula S-EP, where:
S is a block comprising styrene monomer-derived units;
EP is a statistical copolymer comprising ethylene repeat units and propylene repeat units,
the star copolymer (C) comprising at least 10% by weight of styrene monomer-derived units.

23. The copolymer (C) according to claim 21 comprising:
a cross-linked core comprising styrene monomer-derived units; and
arms comprising a statistical copolymer (EP) comprising ethylene repeat units (E) and propylene repeat units (P);
the copolymer (C) comprising at least 10% by weight of styrene monomer-derived units.

24. The copolymer (C) according to claim 22, wherein block S of the S-EP copolymer is positioned on the periphery of the core and the EP copolymer at the ends.

25. The star copolymer (C) according to claim 21 comprising from 10 to 60% by weight of styrene monomer-derived units relative to the total weight of the copolymer (C).

26. The star copolymer (C) according to claim 21, having a weight-average molecular weight (Mw) of between 90 000 and 15 000 000 g/mol.

27. The star copolymer (C) according to claim 21, having 3 to 25 arms.

28. The star copolymer (C) according to claim 21, wherein each of the arms, the same or different, has a weight-average molecular weight (Mw) of between 25 000 and 300 000 g/mol.

29. The star copolymer (C) according to claim 21, wherein the arms are all the same or different and the molecular weight average (Mw) of the arms is between 25 000 and 300 000 g/mol.

30. The star copolymer (C) according to claim 21, wherein the EP copolymer in each of the arms is the same or different and comprises from 14 to 90% by weight of ethylene repeat units relative to the total weight of said EP copolymer.

31. The star copolymer (C) according to claim 21, wherein the EP copolymers in each of the arms are all the same or different and on average comprise from 14 to 90% by weight of ethylene repeat units relative to the average weight of the EP copolymer.

32. The star copolymer (C) according to claim 21, further comprising at least one group comprising at least one polar function located on at least one of the arms.

33. The star copolymer (C) according to claim 21 in the form of a dispersion in an anhydrous medium.

34. Lubricating composition comprising at least one base oil and at least one star copolymer (C) according to claim 21.

35. Lubricating composition comprising from 0.1 to 50% by weight of star copolymer (C), according to claim 21, relative to the total weight of the composition.

36. A method for improving the viscosity index of a lubricating composition, comprising a step of addition of a star copolymer (C) according to claim 21 to said lubricating composition.

37. Method according to claim 36, wherein the star copolymer (C) is added to the lubricating composition in a proportion of from 0.1 to 50% by weight relative to the total weight of the composition.

38. A method for reducing the friction coefficient of a lubricating composition, comprising a step of addition of a star copolymer (C) according to claim 21 to said lubricating composition.

39. A method for reducing the fuel consumption of an engine, comprising a step of applying the lubricating composition according to claim 34 to said engine.

40. Method for preparing a star copolymer (C) according to claim 21, comprising:
a) a step to synthesize a statistical copolymer (EP) comprising ethylene repeat units, propylene repeat units and residual double bonds;
b) a step to functionalise the copolymer (EP) derived from step a) with a nucleophilic addition reactive function;
c) a step to polymerize styrene monomers in the presence of a cross-linking agent;
d) a step to add the polymer derived from step c) onto the copolymer (EP) derived from step b);
e) a step to recover the star copolymer (C) obtained at step d).

41. A method for reducing fuel consumption of an engine lubricated by means of a lubricating composition, comprising a step of addition of a star copolymer (C) according to claim 21 to said lubricating composition.

42. A method for reducing the fuel consumption of a vehicle equipped with a drive axle or gearbox and lubricated by means of a lubricating composition, comprising a step of addition of a star copolymer (C) according to claim 21 to said lubricating composition.

43. A method for reducing the fuel consumption of a vehicle equipped with a transmission and lubricated by means of a lubricating composition, comprising a step of addition of a star copolymer (C) according to claim 21 to said lubricating composition.

44. A method for reducing the traction coefficient of lubricating composition, comprising a step of addition of a star copolymer (C) according to claim 21 to said lubricating composition.

45. A method for improving the Fuel Eco (FE) of a lubricating composition, comprising a step of addition of a star copolymer (C) according to claim 21 to said lubricating composition.

46. A method for reducing the fuel consumption of a vehicle equipped with a drive axle or gearbox, comprising a step of applying the lubricating composition according to claim 34 to said drive axle or gearbox.

47. A method for reducing the fuel consumption of a vehicle equipped with a transmission, comprising a step of applying the lubricating composition according to claim 34 to said transmission.
